(19) United States
(12) Patent Application Publication
(10) Pub. No.: US 2003/0090466 A1
(43) Pub. Date: May 15, 2003

(54) Method for constituting multiple-key-code of compound keys

(76) Inventor: John Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/987,213

(22) Filed: Nov. 14, 2001

(51) Int. Cl. G09G 5/00

(52) U.S. Cl. 345/168

(57) ABSTRACT

The present invention relates to a method for constituting a multiple-key-code of compound keys used as compound key-function keys on a keyboard of a computer. The keyboard has a memory and a microprocessor and the computer has a memory. Both of the memories store a number of pre-established matching key-code tables for selection. When any item on the key function selection manual provided by the computer is selected, the computer will issue a specific key code switch signal to the microprocessor of the keyboard, in order to activate a corresponding key code table, by which a desired setting of key functions can be properly implemented.

### FIELD OF THE INVENTION

The present invention relates to a method for constituting a multiple-key-code of compound keys, in particularly to a method for constituting a multiple-key-code of compound keys installed on the keyboard of a computer.

### BACKGROUND OF THE INVENTION

Keyboards are the major input/output devices for personal computers. For a computer user, the best keyboard is one that is easy to use, and provides as many functions as possible. The function of each key on a conventional keyboard of a personal computer is fixed and confined to a specific purpose when the keyboard is manufactured. Conventional keyboards fail to provide capabilities for users to define the function of keys according to their needs and preferences when handling a specific assignment. Some conventional keyboards provide a number of compound function keys and hot keys for users to select a desired function from a predetermined list of functions. However, these compound or hot keys on the conventional keyboards provide a limited number of predetermined functions and it is very troublesome and inconvenient for the users to memorize the list of functions provided by each of the compound keys, so that the efficiency of using the keyboard is reduced.

### SUMMARY OF THE INVENTION

It is therefore an object of the present invention to provide a method for constituting a multiple-key-code of compound keys that will bring out a multiple-option manual for keys on the monitor screen. So that, users can conveniently select a desired key-code table by selecting appropriate items shown on the manual.

It is another object of the present invention to provide a method for constituting a multiple-key-code of compound keys in which selection of keys for specific functions can be operated in an easy on-screen selection manner without the need of memorizing specific functions of multiple compound keys.

To achieve the above objects, the method for constituting a multiple-key-code of compound key comprises a memory and a microprocessor installed on the keyboard and a memory installed on the computer; both memories store a number of pre-established key-code tables; the computer stores key function selection manuals each matching a key-code table; the action that any item on the key function selection manual is selected will issue a specific key code switch signal to the microprocessor of the keyboard from the computer so as to activate a matching key-code table in the keyboard based on which proper key codes for specific key operations are interpreted.

Other objects, advantages and constructions of the present invention will become more apparent from the following description and the drawings.

### BRIEF DESCRIPTION OF THE DRAWINGS

The present invention will be apparent to those skilled in the art by reading the following description of preferred embodiments thereof, with reference to the accompanying drawings, in which:

FIG. 1 is a block diagram showing the hardware system involved in the present invention.

FIG. 2 is a flowchart showing the operation procedure of key-code table selection.

FIG. 3 is a flowchart showing the procedure of operating a compound key.

### DETAILED DESCRIPTION OF THE PREFERRED EMBODIMENT

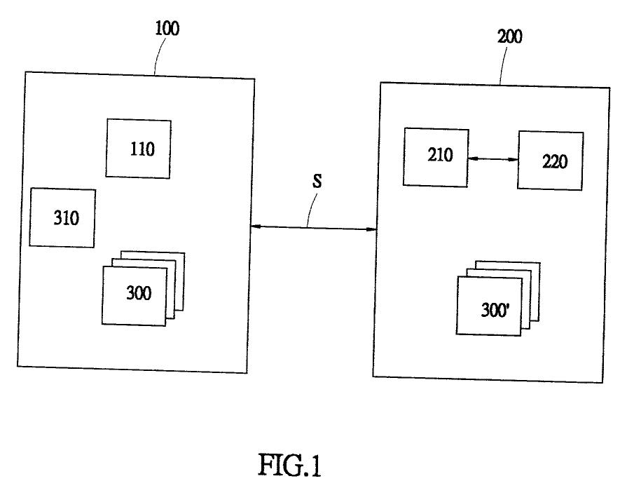

Referring to FIG. 1, the hardware system of the present invention comprises a computer 100 and a keyboard 200. The memory 110 of the computer 100 and the microprocessor 210 or the memory 220 of the keyboard 200 both contain a number of pre-established key-code tables 300 and 300′, respectively. The key-code table 300 is identical to the key-code table 300′, and unlike the conventional key-code table provided by IBM keyboards. The key-code tables 300 and 300′ can be altered and defined by the user by selecting appropriate key function items from the multiple-function compound keys such as re-definition of key functions for better fitting a specific package software or game software. The computer 100 provides the corresponding key function selection manual 310 so that a user can select a desired key-code table 300 from the manual 310. When the user selects a specific key code table setting, the computer 100 will send a key code switch signal S to the microprocessor 210 of the keyboard 200. So that the microprocessor 210 will load the matching key-code table 300′ pre-stored internally or in the memory 220 of the keyboard 200, and the microprocessor 210 of the keyboard 200 will implement corresponding key functions according to the key-code table 300′.

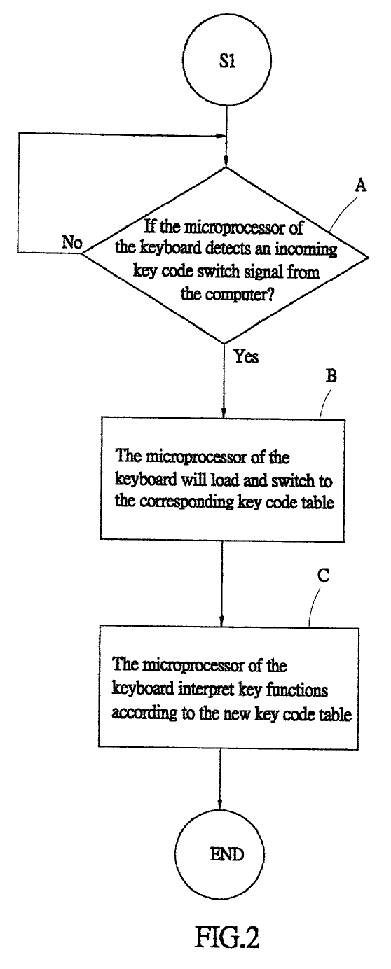

Referring to FIG. 2, the setting and operation procedure of the key code tables of the present invention can be described as follows:

(a) The keyboard continues to detect if the key code switch signal S is sent from the computer. After any items on the key function selection manual 310 provided by the computer 100 are selected by the user, the computer 100 will issue a key code switch signal S to the microprocessor 210 of the keyboard 200;

(b) The microprocessor 210 of the keyboard 200 will load and switch to the corresponding key-code table 300′; and

(c) The microprocessor 210 of the keyboard 200 interpret key functions and compound key functions according to the present key-code table 300′ so that the computer 100 will execute corresponding functions defined by the present key function setting.

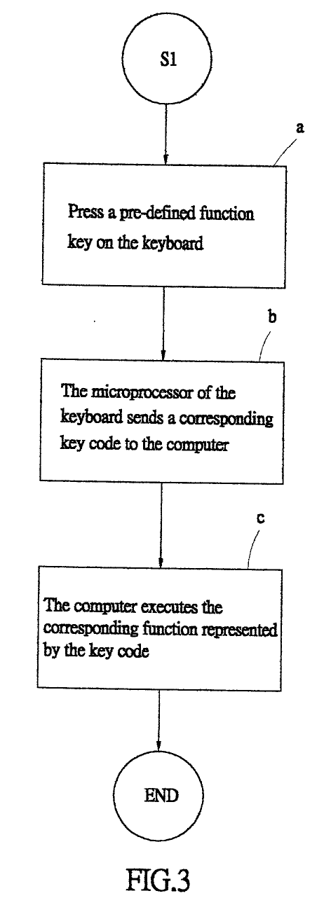

Referring further to FIG. 3, the procedure of key function operation of the present invention can be described as follows:

(a) Press a pre-defined compound key on the keyboard 200;

(b)The microprocessor 210 of the keyboard 200 will send a corresponding key code defined in the newly selected key-code table 300′ to the computer 100; and

(c) After receiving the key code from the keyboard 200, the computer 100 will check the meaning of the key code on the key-code table 300 stored in the memory 110 of the computer 100, and then execute the corresponding function.

By using the hardware system shown in FIG. 1 and key code table setting and operation procedure shown in FIGS. 2 and 3, the computer 100 can execute proper functions based on the key-code tables 300 selected by the user from the key function selection manual 310 provided by the computer 100. So that, it would be much easier to operate a package software or game software which complicated key function operations are constantly demanded. This invention further enables keyboard manufacturers to produce lower-cost single-model keyboards capable of performing a variety of key function combinations.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A method for constituting a multiple-key-code of compound keys comprising a memory and a microprocessor installed on a keyboard and a memory installed on a computer; both of the memory of the keyboard and the memory of the computer storing a number of pre-established key-code tables for selection; the computer also storing key function selection manuals each matching one of the key-code tables; by selecting items on the key function selection manual issuing a specific key code switch signal to the microprocessor of the keyboard in order to activate a corresponding key code table by which a desired key functions setting is established.

2. The method for constituting a multiple-key-code of compound keys as claimed in claim 1, further comprising the operation procedure:
(a) The microprocessor of the keyboard detects a key code switch signal from the computer;
(b) The microprocessor of the keyboard accordingly changes the key code setting to the one requested;
(c) The microprocessor of the keyboard starts to execute key functions according to the present key code setting;
(d) Press any pre-programmed function key;
(e) The microprocessor of the keyboard sends the corresponding key code to the computer; and
(f) The computer executes the corresponding functions defined by the key code.
